(19) United States
(12) Patent Application Publication
(10) Pub. No.: US 2026/0299698 A1
(43) Pub. Date: Oct. 1, 2026

(54) NON-CONTACT INPUT DEVICE

(71) Applicant: INTERMAN CORPORATION, Kagoshima-shi, Kagoshima (JP)

(72) Inventors: Shigeki UETABIRA, Kagoshima-shi (JP); Yoshimasa SAITOH, Tokyo (JP)

(73) Assignee: INTERMAN CORPORATION, Kagoshima-shi, Kagoshima (JP)

(21) Appl. No.: 18/992,261

(22) PCT Filed: May 21, 2023
(86) PCT No.: PCT/JP2023/018848

§ 371 Date: Jan. 8, 2025

(30) Foreign Application Priority Data
Jul. 14, 2022 (JP) 2022-113288

(51) Int. Cl. G06F 3/01; G02B 30/56; G06F 3/03

(52) U.S. Cl. CPC G06F 3/017; G06F 3/0304; G02B 30/56

(57) ABSTRACT

A non-contact input device includes a display device that displays a non-contact interface screen; an operation space located in such a position as not to overlap the non-contact interface screen; and a detection device that detects hand movement of a user in the operation space in a non-contact manner. When the detection device detects the hand movement of the user in the operation space, this hand movement is displayed as a semi-transparent image or a pointer on the non-contact interface screen. This allows the user to perform input operation while confirming the information on the screen without the hand blocking the screen when operating the non-contact interface screen.

### TECHNICAL FIELD

The present invention relates to a non-contact input device that allows to perform input operations without hindrance while viewing the screen.

### BACKGROUND

The new coronavirus has occurred a pandemic and let people know how the densely populated, high-speed and volume transportation society in the 21st century is vulnerable to an infectious disease. In such a situation, everything around us looks an infectious agent so that daily life becomes confining. In fact, it seems necessarily to doubt everything in an infection spread situation.

While it is important to take measures such as wearing a mask, keeping sufficient distances from others, avoiding all crowded spaces, it is inevitable to make minimum contact with an infection route for carrying out life in society. To minimize this risk as small as possible is vital for preventing infection.

For example, in the case of bank ATMs, supermarket self-checkout machines, corporate reception desks, hotel check-ins, etc., an unspecified number of users are required to operate the same touch panel. Such touch panels can be a potential route of infection. In order to avoid this risk, it is necessary to disinfect the touch panel every time the user changes, but such a procedure is rather time-consuming and difficult to carry out satisfactorily.

In recent years, in such a situation, attention has been focused on a technology capable of non-contact manipulation using an aerial image formed in the air with a special optical element. By using this technology, it is possible to realize a completely non-contact interface with the same usability as a conventional touch panel.

For example, in Patent Document 1, a non-contact remote pointer control device with an aerial imaging technology is used to operate a mouse displayed on the device. This is because it is considered unhygienic for a surgeon to touch pointing devices such as a computer mouse during surgery. As such a special optical element, for example, there is an optical imaging device described in Patent Document 2.

### Patent Document

[Patent Document 1] Japanese Unexamined Patent Application Publication No. 2018-147054

[Patent Document 2] International Publication No. WO 2009/131128

### SUMMARY

While one typical application of aerial imaging technology is a non-contact input device as described in Patent Document 1, it has aspects that are inferior in usability compared to operating an actual mouse. Specifically, when operating an aerial display using a real hand, the real hand inevitably overlaps with the aerial display, obstructing the view and making it difficult to see. In contrast, in the case of normal mouse operation for PC work, only a small pointer is displayed on the display, so the display is almost entirely visible as is. Therefore, operating an aerial display can be confusing compared to normal mouse operation.

It is therefore an object of the present invention to provide a non-contact input device that does not obstruct the display when input is made using the hand.

To achieve at least one of the above-mentioned objects, reflecting one aspect of the present invention, a non-contact input device comprises: a display device that displays a non-contact interface screen; an operation space located in such a position as not to overlap the non-contact interface screen; and a detection device that detects hand movement of a user in the operation space in a non-contact manner, wherein when the detection device detects the hand movement of the user in the operation space, this hand movement is displayed on the non-contact interface screen, and the operation of the non-contact interface screen is performed by this hand movement.

In accordance with one embodiment, the hand movement of the user displayed on the non-contact interface screen is displayed semi-transparently, and the user can view the elements constituting the non-contact interface screen through this semi-transparent display.

Furthermore, in accordance with one embodiment, the hand movement of the user displayed on the non-contact interface screen are indicated by a pointer indicating the position of the fingertips.

Furthermore, in accordance with one embodiment, the operation space is located below the non-contact interface screen.

Furthermore, in accordance with one embodiment, the non-contact interface screen is an aerial display.

According to the non-contact input device of the present invention, when operating the non-contact interface screen, the user's hand does not obstruct the screen, allowing input to be performed while confirming information on the screen, enabling smooth input operations.

### BRIEF DESCRIPTION OF DRAWINGS

FIG. 1 is a perspective view showing a non-contact input device 1 in use according to an embodiment of the present invention.

FIG. 2 is a side view showing the non-contact input device 1 in use according to the embodiment of the present invention.

FIG. 3 is a view showing an example of a non-contact interface screen displayed on the non-contact input device 1 according to the embodiment of the present invention.

FIG. 4 is a view showing another example of a non-contact interface screen displayed on the non-contact input device 1 according to the embodiment of the present invention.

FIG. 5 is a view explaining the operation of the non-contact interface screen shown in FIG. 4.

FIG. 6 is a view showing a further example of a non-contact interface screen displayed on the non-contact input device 1 according to the embodiment of the present invention.

FIG. 7 is a view explaining the operation of the non-contact interface screen shown in FIG. 6.

FIG. 8 is a perspective view showing a non-contact input device 5 in use according to another implementation of the embodiment of the present invention.

FIG. 9 is a side view showing the folded state of the non-contact input device 1 according to the embodiment of the present invention.

FIG. 10 is a front view showing the folded state of the non-contact input device 1 according to the embodiment of the present invention.

FIG. 11 is a rear view showing the folded state of the non-contact input device 1 according to the embodiment of the present invention.

FIG. 12 is a view showing a light-blocking curtain used in the non-contact input device 1 according to the embodiment of the present invention.

FIG. 13 is a perspective view showing the light-blocking curtain of FIG. 12 attached to the non-contact input device 1 according to the embodiment of the present invention.

### DETAILED DESCRIPTION

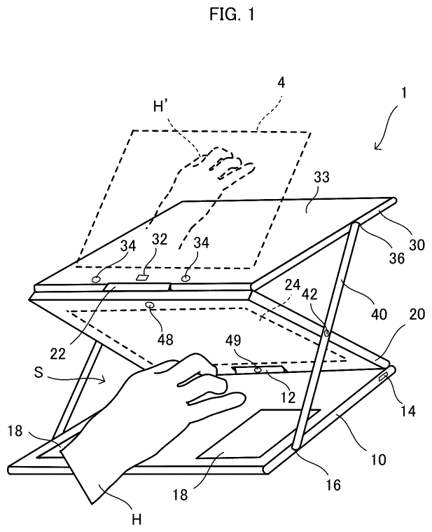

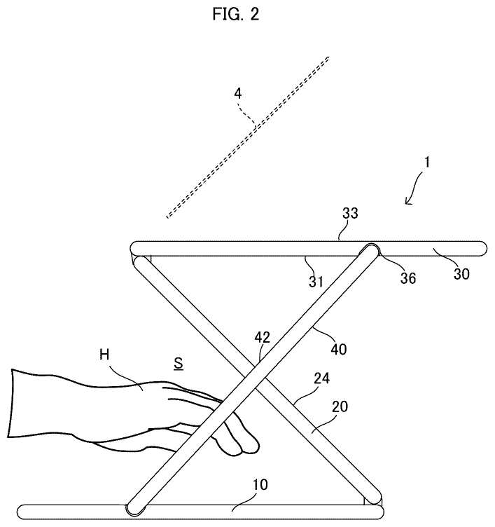

Hereinafter, an embodiment of the non-contact input device according to the present invention will be described with reference to the accompanying drawings. FIG. 1 is a perspective view showing a non-contact input device 1 in use according to the embodiment of the present invention. FIG. 2 is a side view showing the non-contact input device 1 in use according to the embodiment of the present invention.

As shown in these figures, the non-contact input device 1 consists of a support substrate 10 in which an information processing device is implemented that performs overall signal processing, a liquid crystal display 20 connected to this support substrate 10 with a hinge 12, and an optical plate 30 connected to this liquid crystal display 20 with a hinge 22.

The information processing device implemented in the support substrate 10 is essentially a small computer and is composed of a CPU (Central Processing Unit), a ROM (Read Only Memory), a RAM (Random Access Memory), a storage device storing various programs and data, input/output interfaces, and so forth. For example, a USB port 14 and a wireless LAN such as WIFI are implemented as input/output interfaces.

The liquid crystal display 20 has a display surface 24 that faces the optical plate 30. That is, in the operational state of the non-contact input device 1 shown in FIGS. 1 and 2, the display surface 24 is facing diagonally upward. Then, based on the display data sent from the support substrate 10, a non-contact interface is displayed on the display surface 24. The non-contact interface here consists of elements such as buttons, icons, and menus, and by operating these elements, the user can perform input operation to the system.

The optical plate 30 faces the display surface 24 of the liquid crystal display 20 with the incident surface 31 facing downward and the emitting surface 33 facing directly upward. The image on the display surface 24 of the liquid crystal display 20 is then refocused at the same distance on the opposite side of the optical plate 30, forming the same image as an aerial display 4.

As such an optical plate 30, for example, an optical imaging element described in Japanese Unexamined Patent Application Publication No. 2011-175297 can be used. This optical imaging element can be implemented by arranging a large number of flat light reflectors orthogonal to each other at a constant pitch. It is possible to make use of another structure such as a dihedral corner reflector in which reflecting surfaces are formed on the side surfaces of a rectangular hole as described in Japanese Patent No. 4900618.

An infrared LED 32 and a pair of infrared cameras 34 are provided on the optical plate 30 near the hinge member 22. The infrared LED 32 and the infrared camera 34 constitute an operation detection unit that detects an operation performed by the user on the aerial image 4. The detection range of the operation detection unit is defined by the emission angle of the infrared LED 32 and the angle of view of the infrared camera 34.

The support substrate 10, the liquid crystal display 20 and the optical plate 30 are connected by the hinge member 12 and the hinge member 22, respectively, and can be fixed by a pair of left and right locking rods 40 in the operational state of the non-contact input device 1 as shown in FIGS. 1 and 2.

That is, in each of left and right sides, the locking rod 40 is rotatably supported by a shaft 42 provided in the center of the side surface of the liquid crystal display 20, and can be engaged with an engagement recess 16 of the support substrate 10 and an engagement recess 36 of the optical plate 30. When both ends of the locking rod 40 are engaged with the engaging recesses 16 of the support substrate 10 and the engaging recesses 36 of the optical plate 30, the optical plate 30 is horizontally supported, and the liquid crystal display 20 is held at an angle of approximately 45 degrees downward from the optical plate 30. In this use state, the liquid crystal display 20 and the support substrate 10 are fixed at an angle of approximately 45 degrees.

It is important that the angle between the liquid crystal display 20 and the optical plate 30 is about 45 degrees. At this angle, light from the liquid crystal display 20 is imaged under optimal conditions on the aerial display 4. Also, the liquid crystal display 20 and the support substrate 10 are at about 45 degrees, and at this angle, the optical plate 30 becomes horizontal. Specifically, the about 45 degrees should preferably be in the range of approximately 40 degrees to 50 degrees.

When an operation interface is displayed on the liquid crystal display 20 in this state, it is imaged on the opposite side of the optical plate 30 as a non-contact interface 4. When a gesture such as touching the non-contact interface 4 is performed with a finger, the operation is detected by the operation detection unit consisting of the infrared LED 32 and the infrared cameras 34, and a corresponding operation signal is sent to the information processing apparatus of the support substrate 10 for predetermined processing. Operation interfaces include, for example, controls such as buttons, checkboxes, and drop-down menus.

Furthermore, in the non-contact input device 1 according to the present invention, an imaging element 48 is provided at the upper center of the back of the liquid crystal display 20, and an imaging element 49 is provided at the center inside of the hinge 12. The imaging element 48 images the space between the support substrate 10 and the liquid crystal display 20 (hereinafter referred to as the operation space S) from above, and the imaging element 49 images the operation space S between the support substrate 10 and the liquid crystal display 20 from the front. These imaging elements 48 and 49 detect the movement of a hand H inserted into the operation space S between the support substrate 10 and the liquid crystal display 20.

The hand H detected by these imaging elements 48 and 49 is displayed on the display surface 24 of the liquid crystal display 20 and on the aerial display 4 as a focused image through the optical plate 30. However, to avoid obstructing the non-contact interface displayed on the aerial display 4, only the outline H′ of the hand H is displayed, or it is displayed semi-transparently. The operation of the non-contact interface on the aerial display 4 is possible using this hand H′ by moving the hand H.

As a method for detecting the hand H in the operation space S, for example, the positions of the five fingertips can be identified, and from there, an outline H′ or semi-transparent image of the hand H can be created on the aerial display 4. Alternatively, depending on the application, it may be effective to display only a pointer indicating the fingertip instead of an outline or semi-transparent image on the aerial display 4. In this case, the simplest method is to identify only the position of the index fingertip and display a single pointer on the aerial display 4. Alternatively, two pointers could be displayed on the aerial display 4 by identifying the fingertip positions of the index finger and thumb, or five fingertips could be displayed on the aerial display 4 as five pointers. The non-contact interface on the aerial display 4 is operated by moving these pointers.

Therefore, there are two input methods for the non-contact input device 1 of this embodiment. One is the conventional method of directly operating the non-contact interface displayed on the aerial display 4, and the other is the method of operating the non-contact interface displayed on the aerial display 4 not by directly operating it with the hand on the aerial display 4, but by moving the hand H in the operation space between the support substrate 10 and the liquid crystal display 20, through the hand H′ displayed on the aerial display 4.

In other words, when the infrared cameras 34 detect a hand directly operating the non-contact interface displayed on the aerial display 4, input operation is accepted according to that operation. On the other hand, when the imaging elements 48 and 49 detect a hand H, the corresponding movement of the hand H′ is displayed in the aerial display 4 according to that movement to accept input operation through this hand H′.

Alternatively, instead of the hand H′, a pointer is displayed, and input operation is accepted through this pointer.

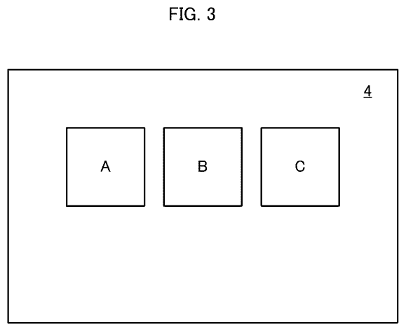

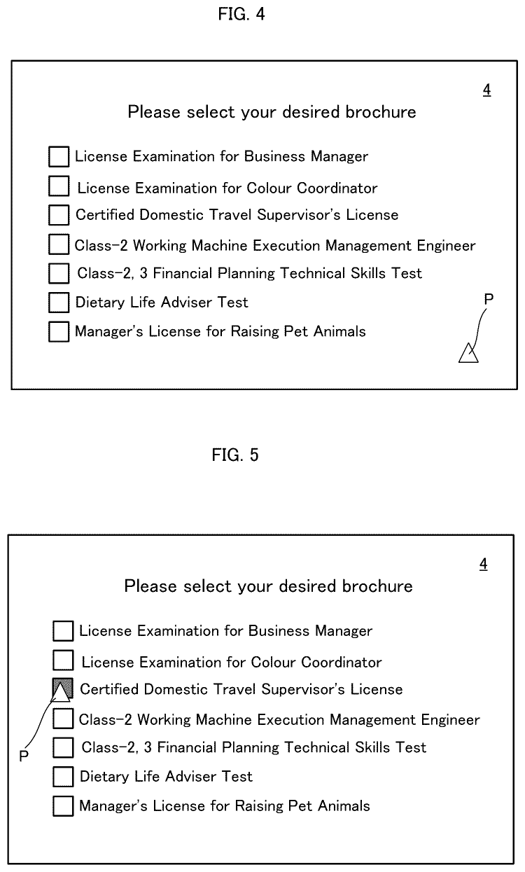

For example, for a simple non-contact interface screen with button selection as shown in FIG. 3, it is easy to directly operate the aerial display 4 with the hand. On the other hand, for a non-contact interface that requires reading text and making multiple selections as shown in FIG. 4 (in this case, checkboxes), the user inserts the hand into the operation space S between the support substrate 10 and the liquid crystal display 20.

Then, the imaging elements 48 and 49 detect the hand H and display a pointer P in the aerial display 4 corresponding to the position of the index finger of the hand H. The user moves his index finger while watching the pointer P in the aerial display 4 to align the pointer P with one of the checkboxes. Then, by keeping the pointer P aligned with one of the checkboxes for a certain time (for example, 3 seconds or more) in that state, the checkbox is selected. Also, by keeping the pointer P aligned with the selected checkbox for a certain time (for example, 3 seconds or more), the selection of the checkbox is canceled (see FIG. 5). With this method, the text of the checkboxes is not hidden by the user's hand, so selection is possible while confirming the content.

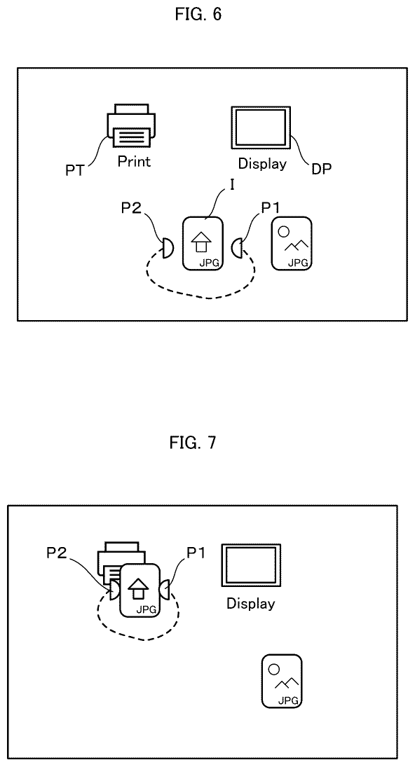

In another example shown in FIG. 6, when the imaging elements 48 and 49 detect the hand H, they identify the positions of the index finger and thumb, and display two pointers P1 and P2 on the non-contact interface screen of the aerial display 4. These two pointers P1 and P2 move according to the movement of the positions of the index finger and thumb.

The user moves the index finger and thumb while watching the pointers P1 and P2 displayed on the aerial display 4, pinching the icon I on the screen with the pointers P1 and P2, and dropping the icon I onto the print icon PT (see FIG. 7). In this case, the icon I represents an image file. When this movement is detected, the system prints the corresponding image with a printer (not shown). If the icon I is dropped onto the display icon DP instead of the print icon PT, the corresponding image is displayed.

As described above, in the embodiment of the non-contact input device according to the present invention, both methods can be used: directly operating the aerial display 4 with the hand, and indirectly operating the non-contact interface screen by inserting the hand into the operation space S provided below.

However, it is also possible to omit the infrared LED 32 and infrared camera 34 and only enable the method of indirectly operating the non-contact interface screen by inserting the hand into the operation space S. In this case, the user will not be confused because there is only one method of operation. Also, in this case, in terms of realizing a non-contact interface, there is no necessity to implement an aerial display. Therefore, it is possible to realize a non-contact input device according to the present invention by constructing a system using only a liquid crystal display without using an aerial display device including the optical plate 30.

FIG. 8 shows a specific example of a non-contact input device that does not use an aerial display device. Here, elements corresponding to each element of the non-contact input device in FIG. 1 are given the same reference numerals in this non-contact input device 5, and their explanations are not repeated. In this case, the optical plate 30 of FIG. 1 is replaced by a liquid crystal display 60, and a support substrate 65 is provided in the position of the liquid crystal display 20 of FIG. 1. However, the liquid crystal display 60 is supported in a position that is easy for the user to see, in a state raised up to the position of the aerial display 4 in FIG. 1.

Similarly, in the non-contact input device 5, an imaging element 48 is provided at the upper center of the back surface of the support substrate 65, and an imaging element 49 is provided at the center inside of the hinge 12. The imaging element 48 images the operation space S from above, and the imaging element 49 images the operation space S between the support substrate 10 and the support substrate 65 from the front. These imaging elements 48 and 49 detect the movement of the hand H inserted into the operation space S.

The hand H detected by these imaging elements 48 and 49 is displayed on the liquid crystal display 60. However, as in the example shown in FIG. 1, to avoid obstructing the non-contact interface displayed on the liquid crystal display 60, only the outline H′ of the hand H is displayed, or the hand is displayed semi-transparently, or a pointer corresponding to the fingertip position is displayed. The operation of the non-contact interface of the aerial display 4 as shown in FIGS. 4 to 7 is possible using this hand H′ by the movement of the hand H.

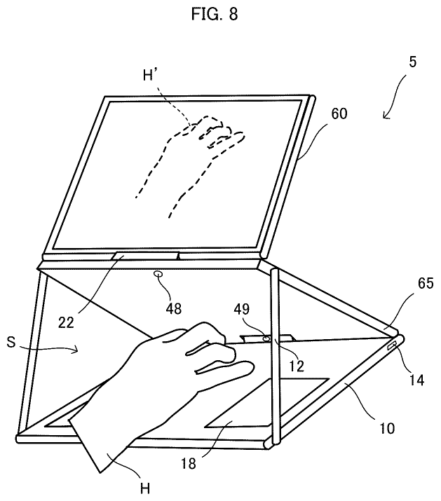

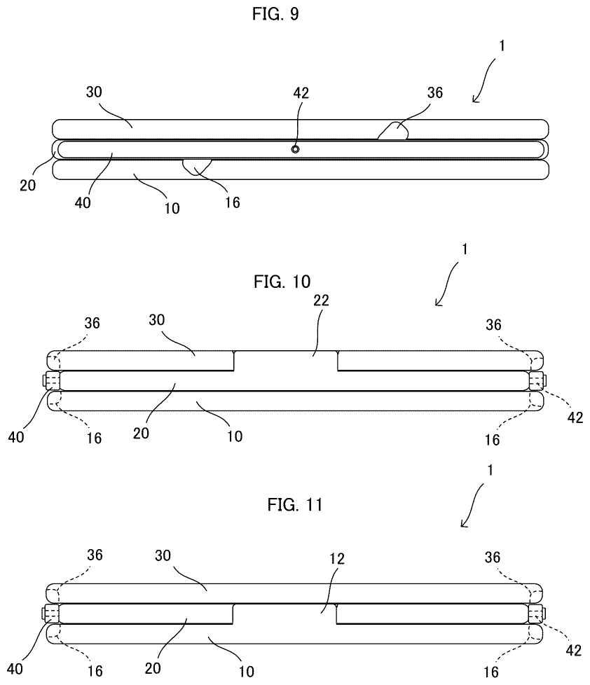

It should be noted that this non-contact input device 1 has excellent portability. That is, when carrying it, the both ends of the locking rod 40 are removed from the engagement recesses 16 of the support substrate 10 and the engagement recesses 36 of the optical plate 30, and the support substrate 10, liquid crystal display 20, and optical plate 30 are rotated around the hinges 12 and 22, and stacked horizontally in a small size as shown in the side view of FIG. 9, the front view of FIG. 10, and the rear view of FIG. 11.

Therefore, the non-contact input device according to the embodiment of the present invention is a portable type that can be folded small and freely carried, for example, it can be put in a bag and carried around, and non-contact online payments can be executed at visited locations.

As shown in FIG. 1, a speaker 18 can also be provided on the support substrate 10. For example, when some operation is performed on the non-contact interface screen 4 and it is detected, the user can be notified with a click sound. In addition, a guidance sound can be played for users who are unfamiliar with the system. Specifically, for an interface screen like FIG. 3, voice guidance saying “Please touch the button on the aerial display directly” can be played, and for an interface screen like FIG. 4, voice guidance saying “Please move your index finger above the support substrate below and align the cursor on the screen with the box on the left side of the item you want to select” can be played.

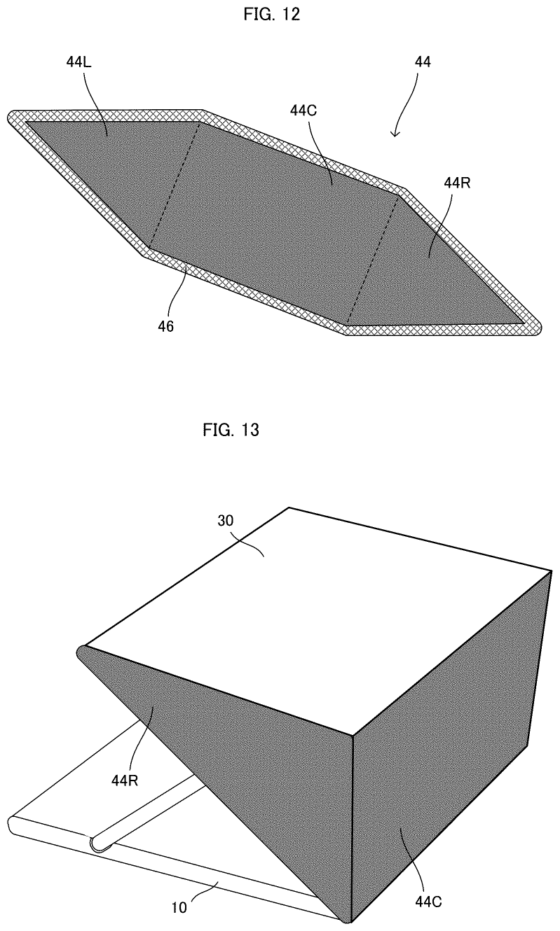

Moreover, in order to realize a clearer aerial image 4, it is desirable that external light is not mixed into the light from the liquid crystal display 20. For this purpose, a light-blocking curtain 44 shown in FIG. 12 can be used. This light-blocking curtain 44 is intended to cover the space between the liquid crystal display 20 and the optical plate 30, and consists of a left shielding part 44L, a central shielding part 44C, and a right shielding part 44R.

The left shielding part 44L covers the open area on the left side between the liquid crystal display 20 and the optical plate 30, the central shielding part 44C covers the open area in the center, that is, the back area between the liquid crystal display 20 and the optical plate 30, and the right shielding part 44R covers the open area on the right side between the liquid crystal display 20 and the optical plate 30.

A hook-and-loop fastener 46 is provided on the edges of the light-blocking curtain 44. Although not directly shown in the figure, the hook-and-loop fastener is also provided on the corresponding surface of the non-contact input device 1. The hook-and-loop fasteners on the light-blocking curtain 44 and the non-contact input device 1 are complementary (one side is the hook part, the other is the loop part), and as shown in FIG. 7, they can be attached to completely cover the space between the liquid crystal display 20 and the optical plate 30. As a result, no external light is added to the light from the liquid crystal display 20, allowing for a clearer aerial image 4.

It should be noted that although the light-blocking curtain 44 is intended to be attached during use, it can be permanently fixed to the liquid crystal display 20 and the optical plate 30 without being attached or removed. In this case, when folding the non-contact input device 1, it is folded between the liquid crystal display 20 and the optical plate 30. The folding method is, for example, a bellows fold, which folds in a zigzag manner like a folding fan.

According to the present invention, a non-contact input device can be realized that allows smooth input operations by enabling input while confirming information on the screen, without the user's hand obstructing the screen when operating the non-contact interface screen.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

For example, although a liquid crystal display is adopted in the above embodiments, the present invention is not limited to this, and organic EL displays or electronic paper, etc., may also be used. Also, although locking rods are used as the support structure to fix the display and the optical plate, the present invention is not limited to this. For example, a locking mechanism can be implemented in the hinge itself, or a shielding plate may be used instead of the light-blocking curtain, and this shielding plate can be utilized also as the support structure to fix the display and the optical plate.

### EXPLANATION OF SYMBOLS

1, 5 and 6 non-contact input device
4 aerial display
10 support substrate
12 hinge member
14 port
16 engagement recess
18 speaker
20 liquid crystal display
22 hinge member
24 display surface
30 optical plate
31 incident surface
32 infrared LED
33 output surface
34 infrared camera
36 engagement recess
40 locking rod
42 shaft
44 light-blocking curtain
44C central shielding part
44L left shielding part
44R right shielding part
46 hook-and-loop fastener
48, 49 imaging element

1-5. (canceled)

6. A non-contact input device comprising:
a display device that displays a non-contact interface screen;
an operation space located in such a position as not to overlap the non-contact interface screen; and a detection device that detects hand movement of a user in the operation space in a non-contact manner, wherein when the detection device detects the hand movement of the user in the operation space, this hand movement is displayed on the non-contact interface screen, and the operation of the non-contact interface screen is performed by this hand movement.

7. The non-contact input device according to claim 6, wherein the hand movement of the user displayed on the non-contact interface screen is displayed semi-transparently, and the user can view the elements constituting the non-contact interface screen through this semi-transparent display.

8. The non-contact input device according to claim 6, wherein the hand movement of the user displayed on the non-contact interface screen are indicated by a pointer indicating the position of the fingertips.

9. The non-contact input device according to claim 6, wherein the operation space is located below the non-contact interface screen.

10. The non-contact input device according to claim 7, wherein the non-contact interface screen is an aerial display.
